(19) United States
(12) Patent Application Publication
(10) Pub. No.: US 2011/0118105 A1
(43) Pub. Date: May 19, 2011

(54) Use of microwave energy to remove contaminating deposits from a catalyst

(75) Inventors: Johannes Schwank, Ann Arbor, MI (US); Steven Edmund, Whitmore Lake, MI (US)

(73) Assignee: The Regents of the university of Michigan, Ann Arbor, MI (US)

(21) Appl. No.: 12/927,526

(22) Filed: Nov. 17, 2010

Related U.S. Application Data
(60) Provisional application No. 61/262,239, filed on Nov. 18, 2009.

(51) Int. Cl. B01J 38/12; B01J 19/08; H01M 8/10; B01J 38/04; B01J 38/10

(52) U.S. Cl. 502/38; 422/186; 429/479; 502/34; 502/53

(57) ABSTRACT

The disclosure relates to apparatus, systems, and methods (a) for performing catalytic reactions using a fixed-bed catalyst (e.g., packed particulate bed or catalyst supported on a monolithic substrate) and (b) for regenerating the catalytic activity of the catalyst. An autothermal reformation (ATR) reaction system is described for illustrative purposes, although the apparatus, systems, and methods can be applied more generally to other catalytic cracking/reformation reaction systems and other catalytic reaction systems, in particular reaction systems in which carbon-based and/or sulfur-based catalyst contaminants are produced during system operation.

### CROSS-REFERENCE TO RELATED APPLICATION

Priority is claimed to U.S. Provisional Application No. 61/262,239, filed Nov. 18, 2009, the disclosure of which is incorporated herein in its entirety.

### FIELD OF THE DISCLOSURE

The disclosure relates to the regeneration of a catalyst whose activity and/or specificity has been degraded by the deposition of a contaminating species on the catalyst.

### BRIEF DESCRIPTION OF RELATED TECHNOLOGY

Hydrocarbon-based energy generation can be achieved through the combined use of a reformer and solid oxide fuel cell (SOFC). Reforming technology converts hydrocarbons into syngas (a mixture including CO and H₂); syngas is then fed into the SOFC to convert chemical energy into electrical energy. Syngas also may be used as a feed to other processes utilizing hydrogen and carbon monoxide. In the reforming process, carbon and coke derived from the hydrocarbon feed often build up on the reforming catalyst and support. Such deposits are detrimental to catalyst function (e.g., activity and/or selectivity).

Carbon and coke deposition occurs more readily on some metals then others. For example, platinum (Pt) will produce less carbonaceous deposits than nickel (Ni). However, platinum is orders of magnitude more expensive than nickel, so materials like nickel having suitable catalytic activity but less than favorable properties with respect to carbonaceous deposits are often incorporated into catalysts. In some cases, it is possible to control process variables to reduce or eliminate coking/carbon deposition. However, this is not feasible in all situations (e.g., such as when little water is available or when there are significant disturbances in the reformer feed concentrations). Reformer units may need to function under less than optimal operating conditions. In mobile power applications, operating conditions are likely to be low in water, as insufficient water would be available from the outlet of the SOFC to ensure full reforming with no coke/carbon formation. Such transient events as startup and shutdown also can lead to carbon deposition and reduced reformer performance.

Presently, the vast majority of commercial fuels as well as potential fuels such as pyrolysis gas contain sulfur and sulfur-containing compounds. In the process of reforming, sulfur deposition onto the catalyst can lead to deactivation of the catalyst, lowering catalyst functionality and process yields. Similar to carbon/coke deposition, sulfur poisoning can be partially controlled via process variables. However, variable process parameters and transient process conditions can limit the ability to control sulfur deposition.

A catalyst can be regenerated by heating the catalyst bed through methods such as resistance heating and/or the addition of fuel and air (e.g., for carbon removal) or a reducing agent (e.g., for sulfur removal) to the reaction region. Both methods require significant energy and are limited by the heat transfer characteristics of the gas and catalyst/support.

### SUMMARY

The disclosure relates to methods and systems for removing contaminants from a catalyst using microwave energy. More specifically, the disclosure relates to the use of microwaves (e.g., applied by a microwave generator and waveguide into a reactor chamber containing catalyst) to remove carbon/coke and/or sulfur from catalyst surfaces (e.g., autothermal reforming (ATR) catalysts such as ceramic, metal, or metal-on-ceramic). Such catalysts are useful in the generation of syngas (i.e., a mixture including CO and H₂), which can be used to generate electricity in combination with a solid oxide fuel cell (SOFC). Combined ATR-SOFC systems provide portable power generation (e.g., having few or no moving-parts) and have significantly improved efficiencies over internal combustion engines in the generation of electricity, and can be incorporated as a power source on electric or internal combustion vehicles. Within the process, solid carbon/coke (i) is oxidized in the presence of a microwave field and an oxidizing atmosphere and (ii) is exhausted from the ATR reactor to regenerate catalyst activity. Similarly, sulfur (i) is reduced in the presence of a microwave field and a reducing atmosphere and (ii) is exhausted from the ATR reactor to regenerate catalyst activity.

In an embodiment, the disclosure relates to a catalytic reaction system comprising: (a) a catalytic reactor comprising (i) an inlet, (ii) an outlet, (iii) a reaction zone between the inlet and the outlet, and (iv) a catalyst fixed in the reaction zone, wherein the inlet and the outlet are in fluid communication through the reaction zone; (b) a microwave source adapted to direct microwave energy into the reaction zone; and (c) optionally, a solid oxide fuel cell comprising a fuel inlet, the fuel inlet of the solid-oxide fuel cell being in fluid communication with the outlet of the catalytic reactor. In a refinement, (i) the reaction zone is defined by an outer wall of the catalytic reactor (e.g., having an opening therein and/or being formed at least in part from a microwave-transparent material); and (ii) the microwave source comprises a magnetron mounted to a waveguide, the waveguide being mounted to direct microwave energy from the magnetron to the reaction zone (e.g., mounted at the opening of the reaction zone outer wall or at a microwave-transparent portion of the outer wall). The microwave source suitably is capable of delivering the microwave energy with a power ranging from 0.01 W to 5000 W and at a frequency ranging from 300 MHz to 30 GHz.

In another embodiment, the disclosure relates to a method of regenerating a catalyst, the method comprising: (a) providing a catalytic reactor comprising (i) an inlet, (ii) an outlet, (iii) a reaction zone between the inlet and the outlet, (iv) a catalyst fixed in the reaction zone and comprising a catalytic material, and (v) a contaminant deposited or adsorbed onto the catalytic material, wherein the inlet and the outlet are in fluid communication through the reaction zone; (b) feeding a catalyst regeneration gas (e.g., oxidizing or reducing gas with or without a hydrocarbon) to the reaction zone; (c) applying a microwave energy into the reaction zone, thereby heating one or more of the catalyst, the catalytic material, and the contaminant; and (d) removing at least a portion of the contaminant from the catalytic material and the reaction zone by reacting at leastaportion of the contaminant with the regeneration gas to form a contaminant-derived reaction product exhaust gas (i.e., a gaseous product resulting from the reaction of the contaminant and the regeneration gas) and removing the exhaust gas from the reaction zone. In a refinement, the contaminant comprises a carbon-containing contaminant, a sulfur-containing contaminant, or a combination thereof. In such a case, removal of at least a portion of the contaminant can include (i) reacting at least a portion of the carbon-containing contaminant with the regeneration gas to form a carbon-containing gas and removing the carbon-containing gas from the reaction zone, (ii) reacting at least a portion of the sulfur-containing contaminant with the regeneration gas to form a sulfur-containing gas and removing the sulfur-containing gas from the reaction zone, or (iii) combinations thereof. In a refinement, the regeneration method comprises feeding the catalytic regeneration gas through the catalytic reactor inlet, where the regeneration gas is substantially free of hydrocarbons or other reaction reactants (i.e., there is substantially no catalytic reaction taking place during the regeneration process). In another refinement, the regeneration method comprises feeding the catalytic regeneration gas through the catalytic reactor inlet, where the regeneration gas further comprises one or more hydrocarbons or other reaction reactants (i.e., catalytic reaction can take place during the regeneration process).

In another embodiment, the disclosure relates to a method of regenerating a catalyst, the method comprising (a) providing a catalytic reactor comprising (i) an inlet, (ii) an outlet, (iii) a reaction zone between the inlet and the outlet, and (iv) a catalyst fixed in the reaction zone and comprising a catalytic material, wherein the inlet and the outlet are in fluid communication through the reaction zone; (b) performing catalytic reaction process comprising: (i) feeding an inlet gas through the inlet and to the reaction zone, the inlet gas comprising a reaction reactant (e.g., one or more hydrocarbons, optionally including oxygen (O₂) and/or water; (ii) maintaining the reaction zone at a temperature and at a pressure sufficient to drive a catalytic reaction of the reaction reactant (e.g., partial oxidation and/or steam reformation, both of which can be balanced for an autothermal process) in the reaction zone and in the presence of the catalyst, thereby forming (A) a reaction product (e.g., including hydrogen and/or carbon monoxide) and (B) a contaminant deposited or adsorbed onto the catalytic material; and (iii) recovering the reaction product from the reaction zone through the outlet; and (c) performing a catalyst regeneration process comprising: (i) feeding a catalyst regeneration gas to the reaction zone; (ii) applying a microwave energy into the reaction zone, thereby heating one or more of the catalyst, the catalytic material, and the contaminant; and (iii) removing at least a portion of the contaminant from the catalytic material and the reaction zone by reacting at least a portion of the contaminant with the regeneration gas to form a contaminant-derived reaction product exhaust gas and removing the exhaust gas from the reaction zone. In a refinement, (i) the contaminant deposited or adsorbed onto the catalytic material comprises one or more a carbon-containing contaminant and a sulfur-containing contaminant; and (ii) removing at least a portion of the contaminant in part (c) comprises (A) reacting at least a portion of the carbon-containing contaminant with the regeneration gas to form a carbon-containing gas and removing the carbon-containing gas from the reaction zone, (B) reacting at least a portion of the sulfur-containing contaminant with the regeneration gas to form a sulfur-containing gas and removing the sulfur-containing gas from the reaction zone, or (C) combinations thereof.

In yet another embodiment, the disclosure relates to another method of regenerating a catalyst, the method comprising: (a) providing a catalytic reactor comprising (i) an inlet, (ii) an outlet, (iii) a reaction zone between the inlet and the outlet, and (iv) a catalyst fixed in the reaction zone and comprising a catalytic material; (b) performing an autothermal reformation process comprising: (i) feeding an inlet gas through the inlet and to the reaction zone, the inlet gas comprising a hydrocarbon, oxygen, and water; (ii) maintaining the reaction zone at a temperature (e.g., 500° C. to 800° C.) and at a pressure (e.g., 20 kPa to 1000 kPa (absolute)) sufficient to drive a partial oxidation reaction and a steam reformation reaction in the reaction zone and in the presence of the catalyst, thereby forming (A) a syngas mixture comprising hydrogen and carbon monoxide and (B) a contaminant deposited or adsorbed onto the catalytic material, the contaminant comprising a carbon-containing contaminant, a sulfur-containing contaminant, or combinations thereof; and (iii) recovering the syngas mixture from the reaction zone through the outlet; and (c) performing a catalyst regeneration process comprising: (i) feeding a catalyst regeneration gas to the reaction zone; (ii) applying a microwave energy into the reaction zone, thereby heating one or more of the catalyst, the catalytic material, and the contaminant; and (iii) removing at least a portion of the contaminant from the catalytic material and the reaction zone by (A) reacting at least a portion of the carbon-containing contaminant with the regeneration gas to form a carbon-containing gas and removing the carbon-containing gas from the reaction zone, (B) reacting at least a portion of the sulfur-containing contaminant with the regeneration gas to form a sulfur-containing gas and removing the sulfur-containing gas from the reaction zone, or (C) combinations thereof. The catalyst regeneration process can be performed at the same time as or in series with the autothermal reformation process.

Various refinements of any of the foregoing embodiments are possible.

The catalyst can be an autothermal reforming catalyst capable of catalyzing the autothermal reformation of a hydrocarbon feed to a syngas mixture comprising hydrogen and carbon monoxide (e.g., nickel and cerium zirconium oxide). Alternatively, the catalyst can comprise a catalytic material selected from the group consisting of a catalytic metal (e.g., cobalt, iron, nickel, palladium, platinum, rhodium, ruthenium, tin, alloys thereof, and combinations thereof), a catalytic metal oxide (e.g., oxides of aluminum, cerium, silicon, and zirconium; oxides of combinations thereof; and combinations thereof), and combinations thereof. The catalyst additionally can comprise a catalytic material supported on a substrate, for example (i) a particulate substrate composition permitting fluid flow through void space defined by the particulate composition in the reaction zone or (ii) a monolithic structure permitting fluid flow through the structure (e.g., a cordierite material defining a plurality of channels therethrough).

The hydrocarbon inlet fuel can be selected from the group consisting of gasoline, kerosene, jet fuel, diesel fuel, ethanol, biodiesel fuel, natural fats and oils, and combinations thereof. Alternatively or additionally, the hydrocarbon fuel can comprise at least one of a linear, branched, and cyclic alkyl, alkenyl, alkynyl, and aryl hydrocarbon group having from 1 to 60 carbon atoms. Suitably, the inlet gas has an oxygen-to-carbon ratio ranging from 0.2 to 2 and a water-to-carbon ratio ranging from 0.5 to 4.

During catalyst regeneration, the microwave energy is suitably applied with a power ranging from 0.01 W to 5000 W and at a frequency ranging from 300 MHz to 30 GHz for a time sufficient to remove at least a portion of the contaminant. As a result, at least 50 wt. % of the contaminant is removed from the catalytic material and the reaction zone during regeneration, based on the weight of the contaminant present before regenerating the catalyst. In an oxidizing regeneration process, (i) the regeneration gas comprises oxygen; (ii) the contaminant comprises the carbon-containing contaminant (e.g., carbon and/or coke); (iii) the microwave energy heats the carbon-containing contaminant, thereby converting at least a portion of the carbon-containing contaminant to the carbon-containing gas and removing the carbon-containing gas from the reaction zone. In a reducing regeneration process, (i) the regeneration gas comprises hydrogen; (ii) the contaminant comprises the sulfur-containing contaminant (e.g., sulfur); (iii) the microwave energy heats one or more of the catalyst and the catalytic material, thereby converting at least a portion of the sulfur-containing contaminant to the sulfur-containing gas and removing the sulfur-containing gas from the reaction zone.

All patents, patent applications, government publications, government regulations, and literature references cited in this specification are hereby incorporated herein by reference in their entirety. In case of conflict, the present description, including definitions, will control.

Additional features of the disclosure may become apparent to those skilled in the art from a review of the following detailed description, taken in conjunction with the examples, drawings, and appended claims, with the understanding that the disclosure is intended to be illustrative, and is not intended to limit the claims to the specific embodiments described and illustrated herein.

### BRIEF DESCRIPTION OF THE DRAWINGS

For a more complete understanding of the disclosure, reference should be made to the following detailed description and accompanying drawings wherein:

FIGS. 1A and 1B are schematics illustrating a catalytic reaction system according to the disclosure that incorporates a microwave energy source to regenerate a catalyst.

FIG. 2 illustrates an ATR catalytic reaction process performed in the reaction system of FIGS. 1A and 1B.

FIG. 3 illustrates a monolithic ATR reaction catalyst including downstream carbon deposits resulting from the reaction process illustrated in FIG. 2.

FIGS. 4 and 5 are thermogravimetric analysis (TGA) plots illustrating the ability to remove carbon and coke from an ATR catalyst system having previously undergone reforming of dodecane. Catalysts samples having undergone microwave radiation applied prior to the TGA procedure (dashed line; “MW”) show a lower derivative weight loss (i.e., shorter peak height [normalized weight loss/° C.]) than catalyst samples subjected directly to the TGA procedure. The TGA plots indicate that carbon has been removed from the catalyst sample during the limited exposure to microwaves prior to conventional heating, since less material is lost upon subsequent heating after microwave exposure.

FIG. 6 illustrates a monolithic partial oxidation reaction catalyst having dark carbon/coke deposits both before a catalyst regeneration process (top image) and after a microwave catalyst regeneration process (bottom image).

FIG. 7 illustrates the application of a catalytic regeneration process according to the disclosure and demonstrates the ability to control the amount of carbon on a catalyst sample after exposure to microwave fields of varying strengths.

FIG. 8 compares the hydrocarbon feed conversion of a catalytic reaction/active regeneration process according to the disclosure with a conventional catalytic deactivation process in the absence of microwave energy.

FIG. 9 compares the effluent reaction product content of a catalytic reaction/active regeneration process according to the disclosure with a conventional catalytic deactivation process in the absence of microwave energy.

FIG. 10 compares the effluent reaction product components of a catalytic reaction/active regeneration process according to the disclosure with a conventional catalytic deactivation process in the absence of microwave energy.

FIG. 11 compares the effluent unreacted feed components of a catalytic reaction/active regeneration process according to the disclosure with a conventional catalytic deactivation process in the absence of microwave energy.

While the disclosed apparatus and methods are susceptible of embodiments in various forms, specific embodiments of the disclosure are illustrated in the drawings (and will hereafter be described) with the understanding that the disclosure is intended to be illustrative, and is not intended to limit the claims to the specific embodiments described and illustrated herein.

### DETAILED DESCRIPTION

The present disclosure relates to apparatus, systems, and methods for (a) performing catalytic reactions using a fixed-bed catalyst (e.g., packed particulate bed or catalyst supported on a monolithic substrate) and (b) regenerating the catalytic activity of the catalyst. The following detailed description is provided in the context of an autothermal reformation (ATR) reaction system, although the apparatus, systems, and methods can be applied more generally to catalytic reaction systems such as other catalytic cracking/reformation reaction systems, in particular reaction systems in which carbon-based and/or sulfur-based catalyst contaminants are produced during system operation.

### Catalytic Reaction System

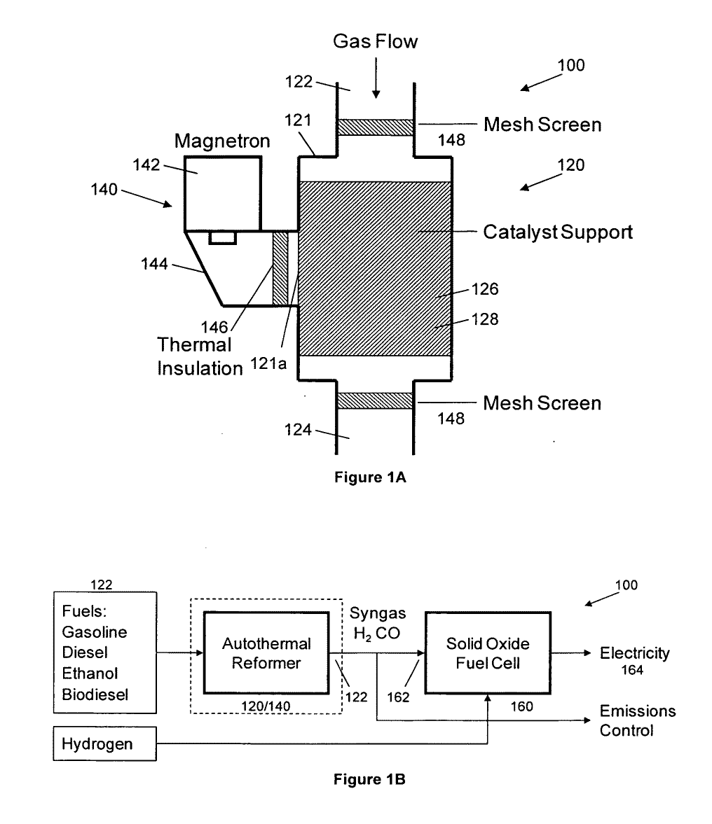

FIGS. 1A and 1B illustrate a catalytic reaction system 100 according to the disclosure. The system 100 generally includes a catalytic reactor 120, a microwave source 140, and (optionally) a solid-oxide fuel cell 160.

The catalytic reactor 120 is generally defined by an outer wall 121 (e.g., of stainless steel and/or quartz construction, generally having a cylindrical or tubular shape) enclosing most of the reactor volume. An inlet 122 and an outlet 124 permit the flow of reactants and products into and out of the reactor 120, respectively. The reactor 120 further includes a reaction zone 126 located between the inlet 122 and the outlet 124 and generally defined by the outer wall 121. A furnace or other heating means (not shown) can be placed upstream of the inlet 122 (e.g., circumferentially positioned around a reactant feed line or tube to the inlet 122) to preheat the reactants before they enter the reaction zone 126 (e.g., to ignite/initiate the reaction therein). A catalyst 128 is fixed in the reaction zone 126. The catalyst, described in more detail below, includes a catalytic material to catalyze the heterogeneous conversion of reactants to products in the reaction zone 126. The inlet 122 and the outlet 124 are in fluid communication through the reaction zone 126 based on the porous or monolithic nature of the catalyst 128.

The microwave source 140 is adapted to direct microwave energy into the reaction zone 126 and/or onto a surface of the catalyst 128 (e.g., by direct absorption of microwave energy from the catalytic material and/or by absorption of microwave energy from contaminants deposited on the catalyst 128). As illustrated, the outer wall 121 defines an opening 121a in the neighborhood of the reaction zone 126. The microwave source 140 includes a magnetron 142 (e.g., further including external electrical and/or electronic connections (not shown) for powering/controlling the microwave source 140) mounted to a waveguide 144. The waveguide 144 is mounted to the opening 121a of the reaction zone 124 outer wall 121 and directs the microwave energy into the reaction zone 126. In another embodiment (not shown), the opening 121a can be omitted and/or the outer wall 121 or a portion thereof can be formed from or otherwise include a microwave-transparent material such as quartz to permit direction of microwave energy into the reaction zone 126 via a suitably positioned waveguide 144. The microwave source 140 is coupled with the catalyst 128 by way of a single- or multi-mode cavity (e.g., the reaction zone 126) in which the catalyst 128 is positioned. The cavity mode is dependent upon the size of the application and is based on generally understood cavity design principles. The interface between the opening 121a and the waveguide 144 suitably is thermally insulated, for example with a low dielectric loss material 146 such as glass wool or a ceramic material. As illustrated, metal screens 148 are included in the inlet 122 and in the outlet 124 to ensure full containment of microwave radiation generated by the microwave source. The position of the metal screens 148 can be adjusted to modify/control the microwave field formed in the reaction zone 126 (e.g., screens that are slidably or otherwise adjustably mounted in the inlet 122 and/or outlet 124).

Microwaves are electromagnetic waves 1 mm to 1 m in length corresponding to frequencies of 300 MHz to 30 GHz. The most common frequency for microwave heating is 2.45 GHz used in household microwave ovens, however many industrial processes also operate at 915 MHz. When an electromagnetic wave comes into contact with a material, the electric field component may be reflected, absorbed, or transmitted. Reflective materials tend to be bulk metals with many free electrons, however it has been widely shown that micron and sub-micron metal particles are strong absorbers of microwaves. Microwave transparent materials tend to have low conductivities associated with members of the glass and ceramics family. Microwave-absorbing materials consist of all those with properties between an ideal conductor and an ideal insulator. Microwave heating occurs due to two primary physical phenomena: dipolar reorientation and conductive heating. Heating of liquids generally results from the polarization and phase lag between dipolar molecules (e.g. water) and the applied electrical field. Heating does not occur in gases, because the natural frequency of reorientation is higher than the microwave frequency. Conversely, in highly constrained polymer or solid systems, where molecules are not free to rotate, dipolar heating is generally not of consequence. Ionic solids heat due to the motion of electrons moving with the electric field. Materials with many free electrons heat well, as do many ceramics at high temperatures, leading to thermal runaway in some systems. The microwave source 140 is not particularly limited and is generally capable of delivering the microwave energy with a power ranging from 0.01 W to 5000 W (e.g., 1 W to 5000 W, 100 W to 5000 W) and at a frequency ranging from 300 MHz to 30 GHz (e.g., 900 MHz to 4 GHz, at 915 MHz, at 2.45 GHz).

The solid oxide fuel cell (SOFC) 160 is a generally known device for the electrochemical generation of electricity from the oxidation of a fuel (e.g., a syngas including hydrogen gas and carbon monoxide gas) using a solid oxide (e.g., ceramic) electrolyte. The illustrated SOFC 160 includes a fuel inlet 162 that is in fluid communication with the outlet 124 of the reactor 120 (e.g., to supply the ATR syngas product stream as the fuel for the SOFC 160). The SOFC 160 generates a DC electrical output 164, which can be converted to an AC electrical source if desired with an appropriate DC/AC converter (e.g., inverter; not shown). Although not shown, unreacted fuel (e.g., hydrogen gas and carbon monoxide gas) and water from the inlet side of the SOFC 160 can be recycled, for example to the SOFC 160 itself and/or the reactor 120.

The catalytic reaction system 100 illustrated in FIG. 1B can be used as electricity-generating component in a variety of settings. For example, an auxiliary power unit (APU) including an ATR reactor 120 and SOFC 160 could function as an electrical r generator on board a truck, silently producing electricity and reducing emissions from diesel fuel with far fewer moving parts and with higher efficiencies than an internal combustion engine. The APU also can be used on a boat (e.g., using gasoline, diesel, or other boat fuel) where quiet power generation is advantageous. For larger scale electricity production, the reaction system 100 can be used with gasified biomass as a hydrocarbon fuel fed into a reformer to transform the fuel into a fuel cell feed.

### Catalyst Materials

The catalyst 128 includes a catalytic material and can optionally include a support substrate onto which the catalytic material is fixed. The catalytic material catalyzes the heterogeneous conversion of reactants to products in the reaction zone 126 of the reactor 120, and can include a catalytic metal and/or a catalytic metal oxide. Suitable catalytic metals include cobalt, iron, nickel, palladium, platinum, rhodium, ruthenium, tin, alloys thereof, and combinations thereof (e.g., co-deposited metals that are not alloyed). The catalytic metals suitably can be deposited onto a support/substrate as a metal salt, calcined to the corresponding metal oxide, and then reduced to the corresponding catalytic metal (e.g., under a reducing atmosphere such as dilute H₂ with conventional or microwave heating). Suitable catalytic metal oxides include: oxides of aluminum, cerium, silicon, and zirconium; oxides of combinations thereof (e.g., cerium zirconium oxide); and combinations thereof (e.g., co-deposited but distinct oxides).

The catalyst 128 generally can be selected for its ability to catalyze any desired reaction within the reactor 120 (e.g., in particular those susceptible to carbon/coke and/or sulfur contamination/deactivation). In an embodiment, the catalyst is an ATR catalyst capable of catalyzing the autothermal reformation of a hydrocarbon feed (discussed below, for example also including oxygen and water) to a syngas mixture including hydrogen and carbon monoxide. For example, a suitable ATR catalyst includes nickel supported on Ce_{0.75}Zr_{0.25}O₂ (CZO), for example with a nickel-to-CZO loading ranging from 0.1 wt. % to 100 wt. % (e.g., 0.2 wt. % to 20 wt. %, 0.5 wt. % to 5 wt. %). As described below, the nickel and CZO (or nickel alone) can be supported on a cordierite monolith, for example with a nickel-to-support loading ranging from 0.1 wt. % to 20 wt. % (e.g., 0.2 wt. % to 10 wt. %, 0.5 wt. % to 5 wt. %) and/or with a CZO-to-support loading ranging from 0.1 wt. % to 40 wt. % (e.g., 0.2 wt. % to 20 wt. %, 0.5 wt. % to 10 wt. %).

In an embodiment, the catalyst 128 includes the support substrate onto which the catalytic material is fixed to form a non-moving catalyst system (e.g., packed bed or monolithic support) in the reactor 120. Suitably, the support substrate is catalytically inert (e.g., substantially inert relative the catalytic material). Additionally, the support substrate suitably has a low dielectric loss (e.g., formed from a ceramic material) so that it does not substantially absorb microwave energy, thereby permitting the selective microwave heating of the catalytic material and/or the contaminants deposited thereon. The substrate can have a particulate structure such that the resulting catalyst 128 composition also has a particulate structure. The particulate structure permits fluid flow through void space defined by the particulate composition in the reaction zone 126. Additionally, the catalyst 128 can have the particulate structure even without the particulate substrate support (e.g., catalyst particles formed essentially entirely from one or more catalytic materials). The specific surface area of a particulate catalyst (whether supported or consisting of catalytic material) can range from 5 m²/g or 20 m²/g to 200 m²/g (e.g., 40 m²/g to 100 m²/g) and can range from 0.02 μm to 5 μm in size (e.g., average size or size distribution). Alternatively, the substrate can have a monolithic structure permitting fluid flow through the structure (e.g., including a regular system of internal channels or being formed from a highly porous material). The presence of a regular system of internal channels in the monolithic substrate can improve the microwave resonance characteristics in the reaction zone 126, thereby improving the distribution and application rate of microwave-induced heating during reactor initiation and catalyst regeneration. In a particular embodiment, the monolithic substrate can be a cordierite (magnesium iron aluminum cyclosilicate) material that is pre-formed with a plurality of channels (e.g., available from Dow Corning, Midland, Mich.) extending longitudinally through the length of the monolith (e.g., in a fluid flow direction from the inlet 122 to the outlet 124 of the reactor 120). The specific surface area of a monolithic substrate having channels therein is about 0.2 m²/g, but can range from 0.4 m²/g to 20 m²/g (e.g., 0.4 m²/g to 5 m²/g, 5 m²/g to 10 m²/g) with one or more catalyst materials deposited thereon. For example, nickel supported on a cordierite monolith can have a specific surface area ranging from 0.4 m²/g to 2 m²/g (e.g., 0.4 m²/g to 1 m²/g); nickel-CZO supported on a cordierite monolith can have a specific surface area ranging from 4 m²/g to 15 m²/g (e.g., 5 m²/g to 10 m²/g). The channels can have a cell density ranging from 100 cells per square inch (cpsi) to 1000 cpsi (15 cells/cm² to 150 cells/cm²) or from 300 cpsi to 500 cpsi (45 cells/cm² to 80 cells/cm²), taking into account the available catalytic surface area and pressure drop across the monolithic structure.

### Catalytic Reaction Process

The catalytic reaction system 100 and/or the catalytic reactor 120 in any of the variously described embodiments can be used to perform a catalytic reaction process and a catalytic regeneration process. The following description relates specifically to an ATR catalytic reaction process.

Autothermal reformers are used to catalytically convert hydrocarbon fuels (e.g., diesel fuel) into syngas, a mixture of primarily hydrogen gas (H₂) and carbon monoxide gas (CO). Reaction 1 below is a simplification of the net ATR reaction system in which the exothermic partial oxidation of a fuel (Reaction 2, “POX”) is used to drive the endothermic steam reforming reaction (Reaction 3, “SR”), both of which produce hydrogen and carbon monoxide. The term autothermal reformation is applied as the feed stoichiometrys for oxygen and water (steam) are substantially balanced to generate a substantially thermally neutral process. The water gas shift reaction (Reaction 4) is generally considered to be in equilibrium at common reaction temperatures when excess water is available in the feed.

CₙHₘ+xO₂+(n−2x)H₂O→>nCO+(n−2x+0.5 m)H₂ (1)

CₙHₘ+0.5nO₂→nCO+0.5 mH₂ [POX](2)

CₙHₘ+nH₂O→nCO+(n+0.5 m)H₂ [SR](3)

CO+H₂O→CO₂+H₂ (4)

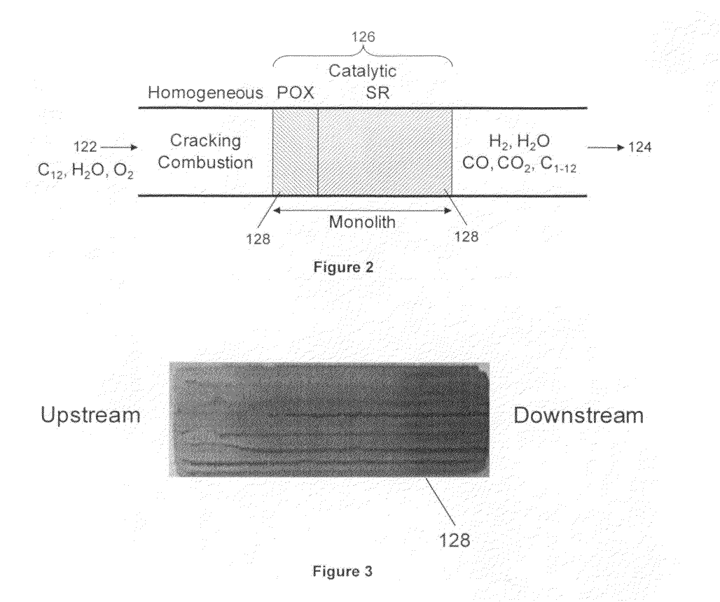

With reference to FIGS. 1A, 1B, and 2, a general ATR process includes (i) feeding an inlet gas through the inlet 122 and to the reaction zone 126 of the reactor 120, (ii) maintaining the reaction zone 126 at a temperature and at a pressure sufficient to drive the partial oxidation reaction (Reaction 2; “POX”) and the steam reformation reaction (Reaction 3; “SR”) in the reaction zone 126 and in the presence of the catalyst 128 to catalyze the formation of the syngas product mixture, and (iii) recovering the resulting syngas product mixture from the reaction zone 126 through the outlet 124. The ATR reaction zone 126 temperature suitably ranges from 500° C. to 800° C. (e.g., 600° C. to 700° C.) and the pressure ranges from 20 kPa to 1000 kPa (absolute). Operating pressures commonly are near atmospheric (e.g., 100 kPa to 200 kPa, about 150 kPa), but can be higher (e.g., up to 1000 kPa) to provide a pressure driving force for downstream flow of the products to other unit operations, or can be sub-atmospheric (e.g., 20 kPa to 50 kPa, 70 kPa, or 100 kPa) to allow plasma reaction conditions. The ATR reaction can be initiated/ignited by pre-heating the inlet 122 to a desired temperature, and such pre-heating can result in some homogeneous cracking and/or combustion of the hydrocarbon fuel. Alternatively, the ATR reaction can be initiated/ignited by applying the microwave energy to the reaction zone 126 while feeding the hydrocarbon fuel to the reactor 120. In this case, the application of microwave energy can be terminated once the reaction zone 126 reaches a temperature sufficient to initiate the reaction, and the exothermic partial oxidation reaction provides sufficient energy to continue to drive the ATR reaction.

The inlet gas for an ATR reaction includes a hydrocarbon-based fuel, oxygen (e.g., alone or as a component of air), and water. Fuels of interest include hydrocarbons relevant for the transportation sector, for example including gasoline, kerosene, jet fuel, and/or diesel fuel. Bio-based hydrocarbon fuels also can be used, for example including alcohols (e.g., ethanol), biodiesel fuel, and/or natural fats/oils (e.g., animal/vegetable fats/oils naturally occurring in a glyceride or triglyceride form that are usable in the glyceride or triglyceride form without a conversion to biodiesel fuel). Alternatively or additionally, the hydrocarbon fuel can be characterized in terms of the number of carbon atoms in its component molecules. For example, the hydrocarbon can include linear, branched, and/or cyclic alkyl, alkenyl, alkynyl, and/or aryl hydrocarbon groups having from 1 to 60 carbon atoms. The hydrocarbons in many cases include only carbon and hydrogen atoms, but can include such hydrocarbon derivatives as alcohols, acids, esters, and (tri)glycerides. Certain suitable sub-ranges for the number of carbon atoms can include 1-2, 1-4, 1-8, and 2-8 (e.g., for light alkane or alcohol feeds such as methane or ethanol); 4-12 (e.g., for gasoline); 6-16 (e.g., for kerosene); 8-16 (e.g., for jet fuel); 8-21 and 8-24 (e.g., for diesel or biodiesel fuel); and 20-60 (e.g., for glycerides or triglycerides of natural oils/fats having side chains ranging from about 12 to 20 carbon atoms). The foregoing carbon ranges can relate to the average number of carbon atoms in the hydrocarbon feed and/or the range of carbon atoms in a multi-component hydrocarbon mixture (e.g., a weight- or number-based average or range). The foregoing hydrocarbon fuels can be used in catalytic systems other than ATR system, for example a system intended to utilize one or more other reaction pathways (e.g., partial oxidation alone, steam reformation alone, partial oxidation and steam reformation combined but not balanced for ATR, one or more other catalytic reactions either alone or in combination with partial oxidation and/or steam reformation).

The oxygen content and water/steam content in the inlet gas can be selected to approximately balance the partial oxidation exotherm with the steam reformation endotherm so that the reaction zone can be maintained at substantially constant reaction temperature without a need to supply further energy to the reaction system and without a need to provide a cooling duty to the reaction system. To this end, the inlet gas suitably has an oxygen-to-carbon ratio up to 2, 3, or 4 (e.g., ranging from 0 to 2, 3, or 4, such as at least 0.2, 0.3, 0.4, or 0.5 and/or up to 1, 1.5, 2, 3, or 4), where the ratio represents the number of oxygen atoms (e.g., from all sources, from molecular oxygen (O₂) alone, from all non-water sources, from non-water sources such as molecular oxygen and/or oxygenated hydrocarbon fuels (e.g., alcohols, ethers, esters)) relative to the number of carbon atoms in the inlet gas. Similarly, the inlet can have a water-to-carbon ratio up to 4 (e.g., ranging from 0 to 4, 0.5 to 4, 1 to 3, or 1.5 to 2.5), where the ratio represents the number of water molecules (or oxygen atoms derived from water molecules) relative to the number of carbon atoms in the inlet gas. When desired, the oxygen and water amounts can be varied from the exotherm/endothem balance, for example to provide excess oxygen to drive a catalytic regeneration reaction or to provide excess water provide an additional microwave heating medium (e.g., liquid water in the reaction zone, water molecules adsorbed onto the catalyst). In an embodiment, limiting cases for the oxygen and water amounts can be selected to operate the reactor only according to the partial oxidation mechanism (e.g., oxygen-to-carbon ratio greater than zero and water-to-carbon ratio substantially equal to zero) or only according to the steam reformation mechanism (e.g., oxygen-to-carbon ratio substantially equal to zero and water-to-carbon ratio greater than zero).

During the catalytic reaction converting the hydrocarbon to syngas, non-product contaminants can be formed and deposited or adsorbed onto the catalytic material of the catalyst, thereby reducing the catalyst's activity and/or selectivity for the intended heterogeneous reaction. In particular, the contaminant(s) can include: a carbon-containing contaminant (e.g., as illustrated in FIG. 3 with darker regions of the catalyst 128 corresponding to increasing degrees of carbon contaminant deposition), a sulfur-containing contaminant (e.g., elemental sulfur adsorbed onto'the catalytic material), or combinations thereof. The carbon-containing contaminant is generally in the form of particulate deposits on the surface of the catalyst/catalytic material and includes elemental carbon (e.g., graphene sheets, graphite, carbon fibers, single walled carbon nanotubes, carbon whiskers, multi-walled carbon nanotubes and amorphous carbon) and/or coke (e.g., elemental carbon derivative material containing at least some hydrogen). The carbon-containing contaminant is generally formed under normal reaction conditions to at least some extent as a by-product from the hydrocarbon feed. Commercial hydrocarbon fuels can contain minor amounts of sulfur and/or sulfur-containing compounds, thus providing a potential source for sulfur-fouling of the catalyst/catalytic material.

### Catalytic Regeneration Process

With reference to FIGS. 1A and 1B, a general catalytic regeneration process includes: (i) feeding a catalyst regeneration gas to the reaction zone 126 (e.g., via the inlet 122 or other inlet (not shown), either alone or in combination with other reactant or hydrocarbon feed gases); (ii) applying a microwave energy into the reaction zone 126, thereby heating the catalyst 128, the catalytic material, and/or the contaminant deposited/adsorbed thereon; and (iii) removing at least a portion of the contaminant from the catalytic material and the reaction zone 126. The microwave energy can be applied with a power ranging from 0.01 W to 5000 W (e.g., 1 W to 5000 W, 100 W to 5000 W, such as at least 50 W, 100 W, 200 W, 400 W, 700 W, 1000 W and/or up to 1000 W, 2000 W, or 5000 W) and at a frequency ranging from 300 MHz to 30 GHz (e.g., 900 MHz to 4 GHz, at 915 MHz, at 2.45 GHz) for a time sufficient to remove at least a portion of the contaminant(s) (e.g., 1 second to 1 hour, 10 seconds to 10 minutes, 30 seconds to 5 minutes, or continuous application simultaneous with the catalytic reaction process). The contaminants are removed by (A) reacting at least a portion of the carbon-containing contaminant with the regeneration gas to form a carbon-containing gas and removing the carbon-containing gas from the reaction zone and/or (B) reacting at least a portion of the sulfur-containing contaminant with the regeneration gas to form a sulfur-containing gas and removing the sulfur-containing gas from the reaction zone. For carbon-contaminant removal, the regeneration gas suitably is an oxidizing gas (e.g., an oxygen (O₂)-containing gas such as air or substantially pure oxygen). For sulfur-contaminant removal, the regeneration gas suitably is a reducing gas (e.g., a hydrogen (H₂)-containing gas such as hydrogen in an inert diluent or substantially pure hydrogen). Because carbon and sulfur generally include regeneration gases having different constituents, the particular composition of the regeneration gas can be varied in time depending on whether the catalytic reactor 120 is intended to operate in a carbon-removal mode or in a sulfur-removal mode at a particular time.

The oxidation and removal of solid carbon/coke on or adjacent to the surface of the catalytic material is shown in Equation 5. Solid carbon in the presence of oxygen and a microwave field produces gaseous carbon dioxide, thus removing the solid carbon as a gaseous exhaust (e.g., via the outlet 124 or other outlet (not shown)). Solid carbon can include graphene sheets, graphite, carbon fibers, single walled carbon nanotubes, carbon whiskers, multi-walled carbon nanotubes and amorphous carbon either adsorbed to or above the surface of the catalyst. A similar reaction may be described for the oxidation of coke. Whereas carbon deposits have no hydrogen present, coke describes deposits of carbonaceous material that are not fully dehydrogenated. Coke, as described here, is a form of carbon deposit with some hydrogen present. In reforming terminology, “carbon” and “coke” are often used synonymously as the carbon-based deposits on a catalyst and/or support that generally consist of many morphologies of intermingled carbon and coke deposits.

C(s)+O₂(g)→CO₂(g) (5)

The reduction and removal of sulfur and/or sulfur containing compounds on or adjacent to the surface of the catalytic material is shown in Equation 6. Sulfur on a catalyst may, react with a reducing agent (e.g., including but not limited to hydrogen) to form gaseous hydrogen sulfide, thus removing the solid sulfur as a gaseous exhaust (e.g., via the outlet 124 or other outlet (not shown)) and leading to the regeneration of the catalyst.

S(s)+H₂(g)→H₂S(g) (6)

The catalytic reaction and regeneration processes can be performed together or separately in the same reactor 120, depending on the instantaneous composition and feed rates of the inlet gas and regeneration gas being fed to the reactor 120. For example, the catalytic reaction and regeneration processes can be performed in series. For an ATR reaction process, (i) the hydrocarbon fuel, oxygen, and water are fed to the reactor 120 for a pre-selected time to perform the catalytic ATR reaction, (ii) the ATR reaction is halted by terminating the hydrocarbon feed, and (iii) the regeneration gas (e.g., substantially free from hydrocarbons) is then fed to the reactor 120 in conjunction with applied microwave energy. Alternatively, the catalyst regeneration process can be performed at the same time as the catalytic reaction process. In this case, the regeneration gas can be fed to the reactor 120 either continuously with the inlet gas (e.g., including the hydrocarbon fuel) or for pulsed durations overlapping the continuous flow of the inlet gas. In an embodiment, the regeneration gas can be the same as a reactant component of the inlet gas. For example, a portion of oxygen gas fed to the reactor 120 can serve as a reactant for the catalytic conversion of one or more hydrocarbon feeds to products (e.g., according to Equations 1, 2, and/or 3), and a portion of the oxygen gas in the same inlet feed can serve as a regeneration gas for the removal of carbon-based contaminants on the catalyst (e.g., according to Equation 5). In such an embodiment, oxygen can be fed to the reactor 120 at a level greater than that required to support the ATR or other relevant catalytic reaction process, in which case a portion of the inlet oxygen serves as the oxidizing regeneration gas to support the removal of carbon-containing contaminants. In another embodiment, even if oxygen is fed to the reactor 120 at a deficient level relative to that desirable for the stoichiometric conversion of the hydrocarbon feed to desired products, at least some of the oxygen can still serve as a regeneration gas for carbon-containing contaminants.

The catalytic regeneration process is relatively efficient and removes a substantial amount of the contaminant(s) (whether carbon- or sulfur-based, depending on the regeneration gas composition) from the catalytic material in the reaction zone 126. Suitably, at least 50 wt. % (e.g., at least about 30%, 40%, 50%, 60%, 70%, 80%, 90%, 95%, or 99% and/or up to about 80%, 90%, 95%, or 99%) of the contaminant(s) is removed from the catalytic material and the reaction zone 126 in the regeneration process, based on the weight of the contaminant present either before regenerating the catalyst or in a system having the same reaction conditions but performed in the absence of microwave regeneration. Alternatively or additionally, the degree of catalyst regeneration is sufficient to maintain catalytic activity/selectivity at a minimum level that allows continuous operation of the reactor 120. For example, the catalytic activity can be maintained such that the absolute or relative conversion of one or more inlet hydrocarbon fuels can achieve a steady/equilibrium value of at least about 50%, 60%, 70%, 80%, or 90% and/or up to about 80%, 90%, 95%, or 99%, based on either the total inlet feed of the particular hydrocarbon fuel (i.e., absolute conversion) or the amount of the inlet feed of the particular hydrocarbon fuel that is converted under the same reaction conditions with a pristine, non-contaminated catalyst (i.e., relative conversion), Expressed another way, the steady/equilibrium value of the conversion of one or more inlet hydrocarbon fuels can be at least about 10%, 20%, 40%, 60%, or 80% and/or up to about 80%, 100%, 150%, or 200% higher than the hydrocarbon fuel conversion under the same reaction conditions in the absence of any microwave regeneration. The foregoing expressions of regeneration efficiency can apply to regeneration processes performed either together or separately with the catalytic reaction process. In general, the degree of contaminant removal can be increased with greater applied microwave power and/or application time; however, the microwave power and time should be selected to prevent damage to the catalyst 128. Thus, because microwave energy is generally applied continuously during the catalytic regeneration process, the microwave power and/or time should be maintained at low enough levels to avoid catalyst overheating and heat-induced damage, such as sintering of the catalytic material and/or support.

Microwave regeneration brings a level of self-regeneration that can be performed while a reactor system is in operation. The mechanism by which carbon and sulfur is removed differ. Carbon directly and strongly absorbs microwave radiation/energy strongly, thus producing the heat to drive the oxidation reaction. Surface-bound sulfur and sulfur compounds do not directly absorb microwave energy; they indirectly receive thermal energy from the catalyst/catalytic material (e.g., via heat conduction from the catalyst components that do absorb microwave energy) to either desorb or react with other surface species before desorption. In contrast, present regeneration techniques are slow, suffering from poor heat transfer within the system. Microwave-induced carbon removal provides volumetric and fast heating of the system, resulting in energy savings and the potential for reforming to continue while regeneration is occurring. In contrast, conventional heating and thermal catalytic regeneration requires heat transfer across reactor components, whereas volumetric microwave heating involves fewer heat transfer limitations. Microwave heating also produces no combustion products within the reactor and heats the solid rather than the gas phase, and at a much greater rate than is possible under traditional methods. Furthermore, the carbon/coke phase undergoing reactions are highly susceptible to microwave energy. Thus, the reacting phase is also the phase being preferentially heated (e.g., carbon/coke generally absorbs microwave energy at a higher rate than a catalytic metal (such as nickel), while gases and certain catalytic support materials (such as ceramics) exhibit little to no microwave heating).

### EXAMPLES

The following examples illustrate the disclosed apparatus, systems, and methods, but are not intended to limit the scope of any claims thereto.

### Examples 1-2

In Examples 1 and 2, dodecane served as a hydrocarbon feed for an autothermal reformation process substantially performed using the materials and steps described in Gould et al., “Dodecane reforming over nickel-based monolith catalysts,” Journal of Catalysis, vol. 250(2), p. 209 (2007) (incorporated herein by reference in its entirety).

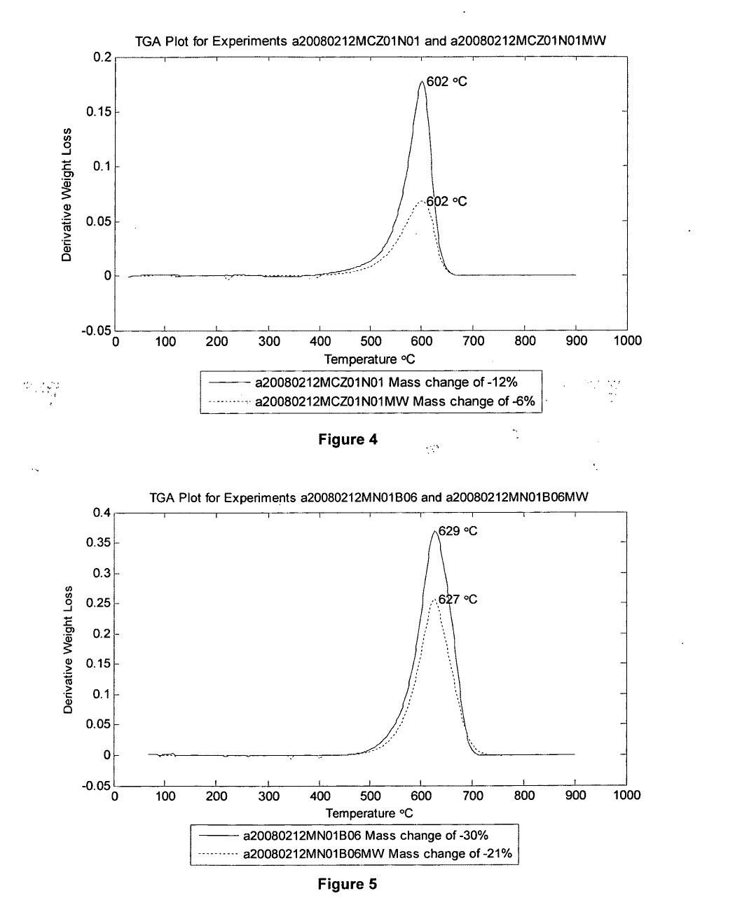

In Example 1, the catalyst consisted of Ni supported on Ce_{0.75}Zr_{0.25}O₂ coated cordierite monoliths (Sample a20080212MCZ01N01). 4.2 wt % Ni was deposited on a Ce_{0.75}Zr_{0.25}O₂ (24.2 wt %)-coated cordierite monolith. The cordierite monolith was about 2 cm in length and 1 cm in diameter, had a cell density of about 400 cells per square inch (cpsi; or 62 cells per square centimeter), and had a wall thickness of about 5.5 mil (or 140 μm). Carbon/coke was deposited on the catalyst during the reforming of dodecane. After the reforming process, a catalyst sample was spread across a quartz boat and irradiated with ˜700 W of microwave radiation using a household microwave oven at 2.45 GHz (Sharp, model #R-202EW) in the presence of air for 1 minute. TGA curves (FIG. 4) were then measured for catalyst/support samples both with and without having undergone microwave treatment. 50% of the carbon/coke on the original sample was removed by 1 minute of MW irradiation. The peak corresponding to the irradiated sample is also skewed to the right, indicating that carbon/coke has been removed form the surface of the catalyst.

In Example 2, the catalyst consisted of Ni supported directly on a cordierite monolith (Sample a20080212MN01B06). 13.2 wt % Ni was deposited on a cordierite monolith similar in structure to that of Example 1. Carbon was deposited on the catalyst during the reforming of dodecane. After the reforming process, a catalyst sample was irradiated with ˜700 W of microwave radiation at 2.45 GHz in the presence of air for 1 minute. TGA curves (FIG. 5) were then measured for catalyst/support samples with and without having undergone microwave treatment. 32% of the carbon/coke on the original sample was removed by 1 minute of MW irradiation. The peak corresponding to the irradiated sample is skewed to the right as in Example 1, however to a lesser extent.

In both Examples 1 and 2, not all of the carbon was removed from the catalyst surface for purposes of comparison. In practice, the microwave time and/or power could be increased to correspondingly increase the net removal of carbon. Thus, the process extends to the partial or complete (or substantially complete to restore catalytic activity) removal of carbon from the catalyst surface as desired based on selected operating conditions.

### Example 3

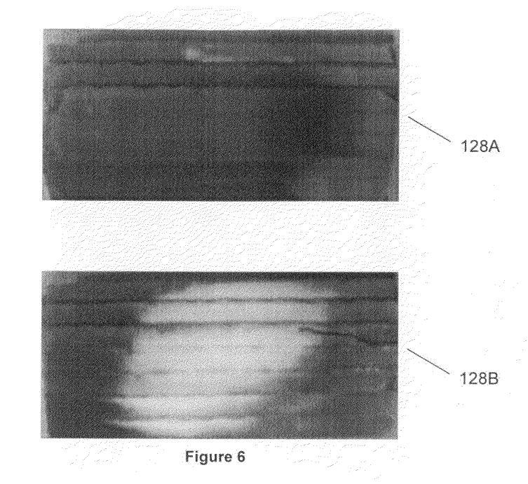

In Example 3, propane served as a hydrocarbon feed for a reformation process using a catalyst consisting of 3.5 wt. % nickel deposited on a cordierite monolith. Carbon was deposited on the sample via the partial oxidation of propane (oxygen:carbon ratio=1.0; gas hourly space velocity=30,000 hr⁻¹) for 5 minutes. The top image of FIG. 6 illustrates the resulting catalyst 128A having a substantial amount of carbon/coke deposit on the exposed surfaces of the catalyst 128A (shown by the darkened regions of the image). The contaminated catalyst 128A was then exposed to microwaves for 15 seconds (at 2.45 GHz) under an oxidizing atmosphere (open air) to yield the regenerated catalyst 128B illustrated in the bottom image of FIG. 6. The regenerated catalyst 128B had a central (white) regenerated region and terminal (darkened) regions where some carbon/coke remained. Gravimetric analysis of the catalyst 128B as a whole indicated that 85% of the total carbon had been removed relative to the contaminated catalyst 128A (i.e., weighting both the central catalyst region where substantially all carbon/coke had been removed and the terminal regions where some carbon/coke remained). Optimization of the applied regenerative microwave field with respect to the microwave distribution over the entire catalyst 128A could result in a more evenly distributed removal of carbon/coke and yield a higher net removal of carbon/coke (i.e., analogous to the central regenerated region of the catalyst 128B, but applied to substantially the entire catalyst).

### Example 4

In Example 4, a catalytic regeneration process was performed simultaneously with a catalytic reaction process for the conversion of propane and ethylene hydrocarbon fuel feeds. A reaction system 100 similar to that illustrated in FIG. 1A was used. A quartz tube formed the body of the reactor 120. The inlet 122 side of quartz tube included a furnace distributed around the quartz tube to pre-heat reactants to about 200° C.-250° C. prior to their entry into the reaction zone 126. A 2.45 GHz microwave waveguide laboratory system (available from Gerling Applied Engineering Inc., Modesto, Calif.) was used as the microwave source 140. The waveguide 144 directed microwave energy through the microwave-transparent quartz tube wall and into the reaction zone 126. The microwave energy was supplied at a level of 0 watts for control experiments in which the microwave was off and no regeneration was performed, thus allowing the accumulation of contaminants on the catalyst 128. The microwave energy was continuously supplied at a level of 70 watts, 250 watts, or 400 watts for regeneration experiments in which the catalyst 128 was regenerated simultaneously with the catalytic conversion of reactants to products.

In Example 4, both regeneration and non-regeneration experiments utilized a catalyst 128 consisting of Ni supported on Ce_{0.75}Zr_{0.25}O₂ coated cordierite monoliths. 10 wt % Ni was deposited via incipient wetness impregnation on Ce_{0.75}Zr_{0.25}O₂. The material was subsequently ball-milled to 1-10 micrometers and wash-coated onto cordierite monoliths. The cordierite monolith was about 2 cm in length and 1 cm in diameter, had a cell density of about 400 cells per square inch (cpsi; or 62 cells per square centimeter), and had a wall thickness of about 5.5 mil (or 140 μm). The catalyst 128 was then supported in the reaction zone 126 of the reactor 120 and in the path of the applied microwave energy from the microwave source 140, and the cells of the monolith permitted fluid communication through the reaction zone 126 from the inlet 122 to the outlet 124.

The reaction system 100 tested in Example 4 was selected to simulate catalyst performance and regeneration under extremely harsh operating conditions. The reactant feed for all trials was a mixture of propane (13.4 mol %, 228 sccm) and ethylene (13.4 mol %, 228 sccm) in air (73.2 mol %, 1263.4 sccm). Water was not fed to the reactor 120, so the reaction system 100 was substantially described by the partial oxidation of the hydrocarbon reactants as in Equation 2. However, water generated in the reactor 120 by other reaction pathways results in the applicability of Equations 1 and 3 to the reaction system 100, albeit not in the stoichiometric balance required for provide an ATR reaction system. Hydrogen gas, which ignites over a nickel catalyst at the furnace pre-heat temperature of about 200° C.-250° C., was fed as a short initial transient along with the other inlet gases, thereby igniting the propane feed and raising the initial reactor temperature to a reaction-sustaining level of about 450° C. All reactions were performed at 9±2 psig and 650±25° C. (i.e., an adiabatic operating point attained by the exothermic reaction after ignition) for a total 15 minute reaction time, during which time the microwave was either off (i.e., for control trials) or continuously on at a constant power level of 70 W, 250 W, or 400 W for regeneration trials).

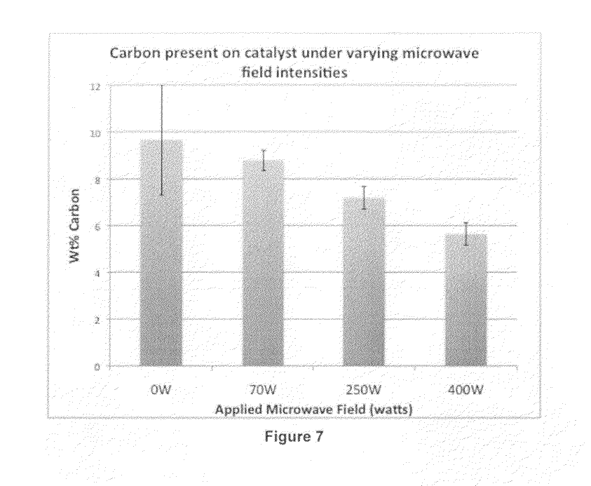

Carbon was deposited on the catalyst 128 during the partial oxidation of the hydrocarbon fuel reactants. FIG. 7 illustrates the ability of the catalytic regeneration process to control/limit the degree of carbon deposition during the catalytic reaction process as a function of the continuously applied microwave energy. After 15 minutes of reaction time and in the absence of any applied microwave energy, originally pristine catalyst 128 samples were determined to have accumulated about 9.8 wt. % carbon relative to the original catalyst weight. As shown in FIG. 7, an increasing level of applied microwave power reduced the accumulation of carbon contamination resulting on originally pristine catalyst 128 samples after 15 minutes of reaction time. At 400 W of continuously applied energy, the catalyst contamination was reduced by nearly 50% (i.e., down to a level of about 5.8 wt. % carbon-on-catalyst).

The results of FIG. 7 illustrate the ability of the disclosed regeneration systems and methods to limit catalyst fouling and extend catalytic life, even under harsh reaction conditions. Specifically, the system was designed and run under very oxygen deficient conditions with the goal of making carbon removal difficult in-vivo as a competitive process performed at the same time as the catalytic conversion of reactants. The distribution of hydrocarbon and air in the feed was selected to yield an oxygen-to-carbon (“O/C”) ratio of about 0.5, which is substantially less than the O/C ratio of 1 required for the stoichiometric conversion of the hydrocarbon fuel to carbon monoxide according to the partial oxidation reaction route (see Equation 2 above). Nonetheless, the data of FIG. 7 demonstrate that at least some catalyst regeneration takes place even under the harsh, oxygen deficient conditions. Thus, in the context of the disclosed catalytic regeneration methods, a portion of the oxygen fed to the reactor 120 functions as a regeneration gas to remove carbon deposits, and a portion of the oxygen fed functions as an inlet/reactant gas to drive the catalytic formation of desired products, even when a less-than-stoichiometric amount of oxygen is fed to the reactor 120. As illustrated by FIG. 7, further increasing the applied microwave power could further decrease the level of carbon accumulation on the catalyst 128. However, care should be taken to avoid increasing the microwave power to a level that overheats and damages the catalyst 128. Alternatively or additionally, the level of carbon accumulation/catalyst regeneration can be further improved by altering the feed composition to increase the oxygen content (e.g., as gaseous oxygen (O₂) and/or water), thereby providing an additional oxygen source for hydrocarbon reactant conversion and leaving a larger amount of oxygen fed as O₂ available for catalyst regeneration (e.g., according to Equation 5).

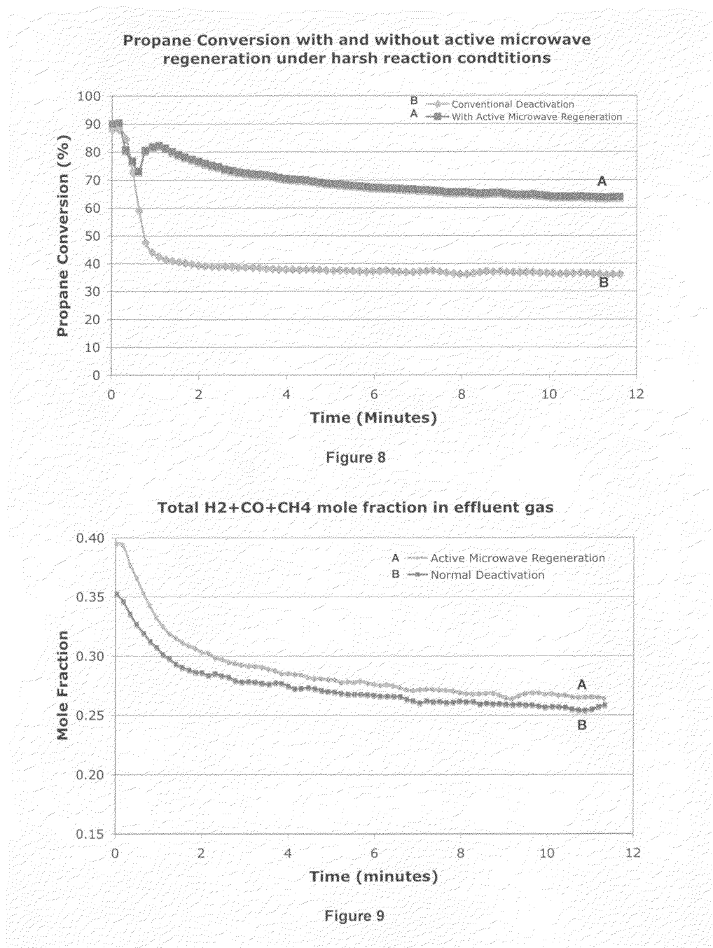

The reaction system 100 of Example 4 was further evaluated on a transient basis for both a control (i.e., non-regenerative) system in the absence of microwave power and a regenerative system subject to 400 W of continuously applied microwave energy. FIGS. 8-11 illustrate the transient results and demonstrate an approach to approximately steady reaction conditions after about 10 minutes of reaction time (summarized in Table 1 below). In Table 1, the effluent mole fractions do not completely sum to unity, a likely result of measurement variations and the non-quantitation of minor reaction products (e.g., water, which was removed from the outlet stream prior to measurement of component concentrations). FIG. 8 illustrates the transient propane conversion for the two cases. The catalyst 128 in the non-regenerative system undergoes significant initial deactivation (i.e., within about 1 minute) that is not seen in the sample exposed to a regenerating microwave field. Further, propane conversion in the actively regenerated system is about 25%-30% higher than that of the non-regenerated system, attaining a conversion of about 63% after 11 minutes of reaction time (i.e., compared to a propane conversion of about 38% in the non-regenerated system).

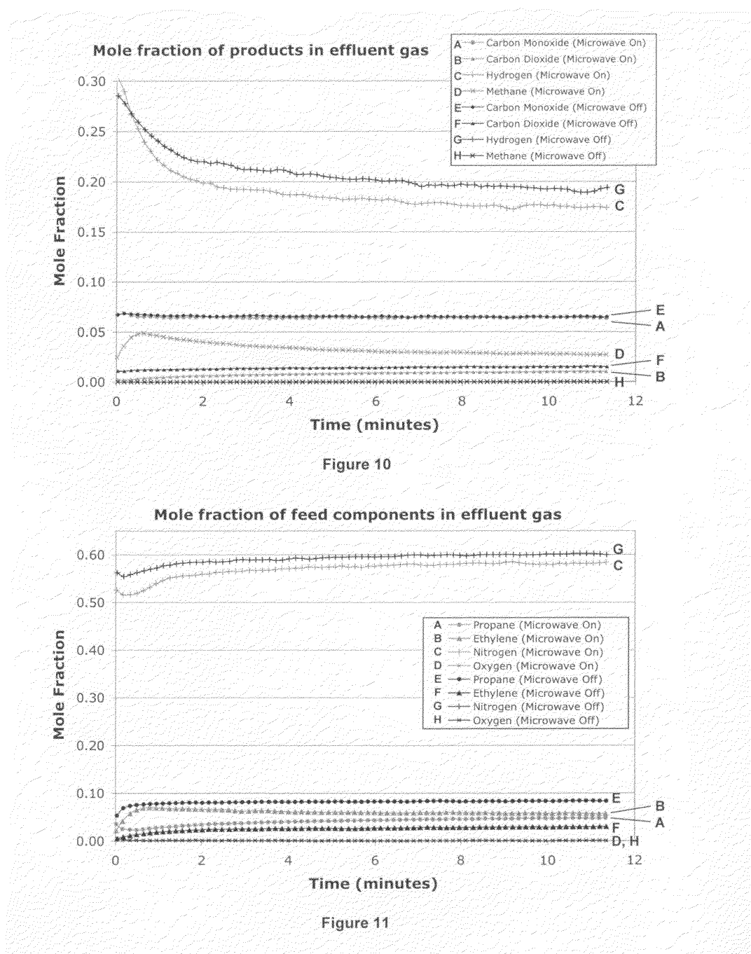

FIGS. 9-11 illustrate transient component mole fractions for the effluent gases in the two cases. As particularly seen in FIGS. 9 and 10 as well as Table 1, active microwave regeneration increases the amount of gas available for performing useful operations (i.e., hydrogen, carbon monoxide, and methane) such as electrochemical energy conversion or chemical synthesis). In the case of active microwave regeneration, methane production could a result of one or more microwave-induced mechanisms such as (i) cracking of the hydrocarbon fuel, (ii) methanation of carbon monoxide and/or carbon dioxide product gases with a hydrogen source such as the hydrogen product gas, and (iii) deposited solid carbon being microwave-heated and reacting with a hydrogen source such as the hydrogen product gas. Similarly, the data in FIG. 11 and Table 1 illustrate a net increase in the consumption of hydrocarbon reactants (i.e., an increase in propane conversion that is partially offset by a decrease in ethylene conversion, where the increased ethylene could be a result of microwave-induced cracking or dehydrogenation of propane). Thus, the application of microwave energy in an active regeneration process appears to introduce additional reaction pathways for the catalytic reaction process (e.g., cracking or dehydrogenation of a hydrocarbon reactant, consumption/conversion of a hydrogen product) that can lead to the interconversion of some reactants and/or products. In any event and regardless of any potential microwave-induced reaction pathways, the data illustrate that an active microwave regeneration process can achieve both (1) a reduced level of carbon/coke catalyst contamination (FIG. 7) and (2) a net increase in reactant conversion/product formation (FIGS. 9-11 and Table 1). Further, this combination of benefits is obtained even in an oxygen-deficient environment; an increase in the level of oxygen fed to the reactor (e.g., as molecular oxygen, water, or otherwise) could provide sufficient oxygen for both a higher yield/conversion as well as catalyst regeneration.

TABLE 1
Feed and Steady Effluent Component Mole Fractions

Steady Effluent

| Component | Inlet/Feed | MW = 400 W | MW = 0 W |
|---|---|---|---|
| C₃H₈ | 0.134 | 0.05 | 0.085 |
| C₂H₄ | 0.134 | 0.06 | 0.03 |
| O₂ | 0.154 | 0 | 0 |
| N₂ | 0.578 | 0.58 | 0.60 |
| CO | 0 | 0.065 | 0.065 |
| H₂ | 0 | 0.175 | 0.195 |
| CH₄ | 0 | 0.030 | 0 |
| CO₂ | 0 | 0.010 | 0.015 |

Because other modifications and changes varied to fit particular operating requirements and environments will be apparent to those skilled in the art, the disclosure is not considered limited to the examples chosen for purposes of illustration, and covers all changes and modifications which do not constitute departures from the true spirit and scope of this disclosure.

Accordingly, the foregoing description is given for clarity of understanding only, and no unnecessary limitations should be understood therefrom, as modifications within the scope of the disclosure may be apparent to those having ordinary skill in the art.

Throughout the specification, where the compositions, processes, apparatus, or systems are described as including components, steps, or materials, it is contemplated that the compositions, processes, or apparatus can also comprise, consist essentially of, or consist of, any combination of the recited components or materials, unless described otherwise. Component concentrations expressed as a percent are weight-percent (% w/w), unless otherwise noted. Numerical values and ranges can represent the value/range as stated or an approximate value/range (e.g., modified by the term “about”). Combinations of components are contemplated to include homogeneous and/or heterogeneous mixtures, as would be understood by a person of ordinary skill in the art in view of the foregoing disclosure.

What is claimed is:

1. A catalytic reaction system comprising:
(a) a catalytic reactor comprising (i) an inlet, (ii) an outlet, (iii) a reaction zone between the inlet and the outlet, and (iv) a catalyst fixed in the reaction zone, wherein the inlet and the outlet are in fluid communication through the reaction zone;
(b) a microwave source adapted to direct microwave energy into the reaction zone; and
(c) optionally, a solid oxide fuel cell comprising a fuel inlet, the fuel inlet of the solid-oxide fuel cell being in fluid communication with the outlet of the catalytic reactor.

2. The catalytic reaction system of claim 1, wherein the catalyst comprises a catalytic material selected from the group consisting of a catalytic metal, a catalytic metal oxide, and combinations thereof.

3. The catalytic reaction system of claim 1, wherein the catalyst comprises a catalytic material comprising nickel and cerium zirconium oxide.

4. The catalytic reaction system of claim 1, wherein the catalyst comprises a catalytic material supported on a monolithic cordierite substrate defining a plurality of channels permitting fluid flow therethrough.

5. The catalytic reaction system of claim 1, wherein the catalytic reaction system comprises the solid oxide fuel cell.

6. A method of regenerating a catalyst, the method comprising:
(a) providing a catalytic reactor comprising (i) an inlet, (ii) an outlet, (iii) a reaction zone between the inlet and the outlet, (iv) a catalyst fixed in the reaction zone and comprising a catalytic material, and (v) a contaminant deposited or adsorbed onto the catalytic material, wherein the inlet and the outlet are in fluid communication through the reaction zone;
(b) feeding a catalyst regeneration gas to the reaction zone;
(c) applying a microwave energy into the reaction zone, thereby heating one or more of the catalyst, the catalytic material, and the contaminant; and
(d) removing at least a portion of the contaminant from the catalytic material and the reaction zone by reacting at least a portion of the contaminant with the regeneration gas to form a contaminant-derived reaction product exhaust gas and removing the exhaust gas from the reaction zone.

7. The method of claim 6, wherein:
(i) the contaminant deposited or adsorbed onto the catalytic material comprises one or more a carbon-containing contaminant and a sulfur-containing contaminant; and
(ii) removing at least a portion of the contaminant in part (d) comprises (A) reacting at least a portion of the carbon-containing contaminant with the regeneration gas to form a carbon-containing gas and removing the carbon-containing gas from the reaction zone, (B) reacting at least a portion of the sulfur-containing contaminant with the regeneration gas to form a sulfur-containing gas and removing the sulfur-containing gas from the reaction zone, or (C) combinations thereof.

8. The method of claim 7, wherein:
(i) the regeneration gas comprises oxygen;
(ii) the contaminant comprises the carbon-containing contaminant;
(iii) the microwave energy heats the carbon-containing contaminant, thereby converting at least a portion of the carbon-containing contaminant to the carbon-containing gas and removing the carbon-containing gas from the reaction zone.

9. The method of claim 8, wherein the carbon-containing contaminant comprises at least one of elemental carbon and coke.

10. The method of claim 7, wherein:
(i) the regeneration gas comprises hydrogen;
(ii) the contaminant comprises the sulfur-containing contaminant;
(iii) the microwave energy heats one or more of the catalyst and the catalytic material, thereby converting at least a portion of the sulfur-containing contaminant to the sulfur-containing gas and removing the sulfur-containing gas from the reaction zone.

11. The method of claim 6, comprising feeding the catalytic regeneration gas through the catalytic reactor inlet, the regeneration gas being substantially free of hydrocarbons.

12. The method of claim 6, comprising feeding the catalytic regeneration gas through the catalytic reactor inlet, the regeneration gas further comprising one or more hydrocarbons.

13. A method of regenerating a catalyst, the method comprising:
(a) providing a catalytic reactor comprising (i) an inlet, (ii) an outlet, (iii) a reaction zone between the inlet and the outlet, and (iv) a catalyst fixed in the reaction zone and comprising a catalytic material, wherein the inlet and the outlet are in fluid communication through the reaction zone;
(b) performing catalytic reaction process comprising:
(i) feeding an inlet gas through the inlet and to the reaction zone, the inlet gas comprising a reaction reactant;
(ii) maintaining the reaction zone at a temperature and at a pressure sufficient to drive a catalytic reaction of the reaction reactant in the reaction zone and in the presence of the catalyst, thereby forming (A) a reaction product and (B) a contaminant deposited or adsorbed onto the catalytic material; and
(iii) recovering the reaction product from the reaction zone through the outlet; and
(c) performing a catalyst regeneration process comprising:
(i) feeding a catalyst regeneration gas to the reaction zone;
(ii) applying a microwave energy into the reaction zone, thereby heating one or more of the catalyst, the catalytic material, and the contaminant; and
(iii) removing at least a portion of the contaminant from the catalytic material and the reaction zone by reacting at least a portion of the contaminant with the regeneration gas to form a contaminant-derived reaction product exhaust gas and removing the exhaust gas from the reaction zone.

14. The method of claim 13, wherein:
(i) the contaminant deposited or adsorbed onto the catalytic material comprises one or more a carbon-containing contaminant and a sulfur-containing contaminant; and
(ii) removing at least a portion of the contaminant in part (c) comprises (A) reacting at least a portion of the carbon-containing contaminant with the regeneration gas to form a carbon-containing gas and removing the carbon-containing gas from the reaction zone, (B) reacting at least a portion of the sulfur-containing contaminant with the regeneration gas to form a sulfur-containing gas and removing the sulfur-containing gas from the reaction zone, or (C) combinations thereof.

15. The method of claim 14, wherein the inlet gas comprises a hydrocarbon.

16. The method of claim 15, wherein the inlet gas further comprises an oxygen source selected from the group consisting of oxygen (O₂), water, and combinations thereof.

17. The method of claim 16, wherein:
(i) the catalytic reaction performed in part (b) comprises one or more of a partial oxidation reaction and a steam reformation reaction;
(ii) the reaction product comprises hydrogen and carbon monoxide.

18. The method of claim 17, wherein:
(i) the inlet gas comprises the hydrocarbon, the oxygen, and the water;
(ii) the catalytic reaction process performed in part (b) is an autothermal reformation process; and
(iii) the inlet gas has an oxygen-to-carbon ratio ranging from 0.2 to 2 and a water-to-carbon ratio ranging from 0.5 to 4.

19. The method of claim 14, wherein the hydrocarbon is selected from the group consisting of gasoline, kerosene, jet fuel, diesel fuel, ethanol, biodiesel fuel, natural fats and oils, and combinations thereof.

20. The method of claim 14, wherein the hydrocarbon comprises at least one of a linear, branched, and cyclic alkyl, alkenyl, alkynyl, and aryl hydrocarbon group having from 1 to 60 carbon atoms.

21. The method of claim 14, comprising performing the catalytic reaction process and the catalyst regeneration process in series.

22. The method of claim 14, comprising performing the catalytic reaction process at the same time as the catalyst regeneration process.
